(19) United States
(12) Patent Application Publication
(10) Pub. No.: US 2025/0148929 A1
(43) Pub. Date: May 8, 2025

(54) SYSTEM OF GENERATING MULTI-STYLE LEARNING TUTORIALS BASED ON LEARNING PREFERENCE EVALUATION

(71) Applicant: Xuzhou Medical University, Xuzhou (CN)

(72) Inventors: Xiang Wu, Xuzhou (CN); Huaqing Hong, Xuzhou (CN); Yongting Zhang, Xuzhou (CN); Lili Wang, Xuzhou (CN); Xiao Zhang, Xuzhou (CN)

(21) Appl. No.: 19/017,783

(22) Filed: Jan. 13, 2025

(30) Foreign Application Priority Data
Mar. 20, 2024 (CN) 202410316016.7

(51) Int. Cl. G09B 7/00

(52) U.S. Cl. CPC G09B 7/00

(57) ABSTRACT

Provided is a system of generating multi-style learning tutorials based on learning preference evaluation. The system dynamically explores preferences of learners in a learning process from a time dimension through a proposed deep reinforcement learning model, so that a deep reinforcement learning agent can accurately express learning behavior features of learners and realize the personalized and accurate construction of course tutorials. At the same time, using an internal knowledge base and an external knowledge base as resource support, a multi-modal knowledge map with a plurality of definition relationships is designed to overcome the limitations of construction of a course tutorial method.

### TECHNICAL FIELD

The present disclosure relates to the technical field of multi-style learning tutorial generation, and in particular to a system of generating multi-style learning tutorials based on learning preference evaluation.

### BACKGROUND

A generative artificial intelligence technology represented by chatGPT has quickly become the focus of intelligent education research, especially in the field of accurate generation of personalized learning resources. An accurate learning resource generation method can provide customized learning experience according to learning styles, abilities and interests of learners, help learners quickly screen a large number of learning resources, and significantly improve the learning efficiency. Although these methods recommend a course, the methods cannot generate personalized tutorials according to preferences of learners. For example, some learners prefer text courses, while others prefer visual tutorials of the same course. Providing the same course for everyone will lead to poor learning results. More importantly, learning preferences of learners may change and be influenced by emotions and knowledge reserves, such as changes in visual preferences of texts. The current methods generally assume that learning preferences of learners are static and the learning paths are continuous or fixed, which means that the current methods cannot meet the demand of dynamic learning preferences of learners and need better actual availability. Therefore, there is an urgent need for an intelligent and self-organized course tutoring method to meet preferences of learners.

### SUMMARY

The present disclosure solves the problems of personalized course resource demand and the dynamic change of learning preferences of learners resulted from the differences of learning preferences of different learners.

The present disclosure provides a system of generating multi-style learning tutorials based on learning preference evaluation, wherein the system includes a learning preference evaluation module, a tutorial matching module, a match revision module and a teaching evaluation module; wherein
the learning preference evaluation module is internally provided with a learning style evaluation scale for evaluating learning preferences of students;
the tutorial matching module is internally provided with a matching rule of a learning preference type and a content style for generating learning style tutorial contents corresponding to learning preferences of users; wherein the matching rule of the learning preference type and the content style is designed as follows:
the learning preference type includes A <active type A1, reflective type A2>, B <feeling type B1, intuitive type B2>, C <visual type C1, literal type C2>, D <sequential type D1, overall type D2>, the eight types are mutually exclusive, and the final evaluation results include only four types out of the eight types;
the content style includes four styles: a text style, a picture style, a video style and an audio style;
the weights of four content styles corresponding to the active type A1 are [50%, 50%, 50%, 50%, 50%], respectively;
the weights of four content styles corresponding to the reflective type A2 are [60%, 50%, 50%, 50%], respectively;
the weights of four content styles corresponding to the feeling type B1 are [40%, 60%, 60%, 50%], respectively;
the weights of four content styles corresponding to the intuitive type B2 are [40%, 80%, 80%, 60%], respectively;
the weights of four content styles corresponding to the visual type C1 are [30%, 90%, 90%, 50%], respectively;
the weights of four content styles corresponding to the literal type C2 are [90%, 50%, 30%, 40%], respectively;
the weights of four content styles corresponding to the sequential type D1 are [50%, 50%, 30%, 30%], respectively;
the weights of four content styles corresponding to the overall type D2 are [50%, 50%, 50%, 50%, 50%], respectively;
after obtaining the combination of four learning preference types, the text t_p, the picture p_p, the video v_p and the audio a_p are obtained by adding the weights of four content styles and dividing the total weights by 4, that is:

$$t\_p = \frac{{A}_{i} ( 1 ) + {B}_{i} ( 1 ) + {C}_{i} ( 1 ) + {D}_{i} ( 1 )}{4} ;$$

$$p\_p = \frac{{A}_{i} ( 2 ) + {B}_{i} ( 2 ) + {C}_{i} ( 2 ) + {D}_{i} ( 2 )}{4} ;$$

$$v\_p = \frac{{A}_{i} ( 3 ) + {B}_{i} ( 3 ) + {C}_{i} ( 3 ) + {D}_{i} ( 3 )}{4} ;$$

$$a\_p = \frac{{A}_{i} ( 4 ) + {B}_{i} ( 4 ) + {C}_{i} ( 4 ) + {D}_{i} ( 4 )}{4} ;$$

where i=1, 2;
the match revision module is internally provided with a style adaptability star-rating and revision rule for revising the learning style tutorial contents and generating the learning style tutorial contents in the next section; wherein the revision rule includes the following steps:
S11, giving a critical definition of the revision rule:
definition of a state: S=(U, V, T) is used to represent the current dynamic state based on a learning path, where U denotes advice to learners, V denotes the entity that a deep reinforcement learning agent arrives at, and T denotes the entity accessed by the agent in which an access path is recorded;
definition of an action space: after the reinforcement learning agent is in a specific state, it is necessary to obtain the action space in this state, select an action from this space, start the action, and then transmit the action to the next state; wherein the action space is defined as follows:

$${A}_{s t} = \{ ( r , {V}_{t + 1} ) , ( {V}_{t} , r , {V}_{t + 1} ) ∈ R \} ;$$

where r denotes the relationship between entities, r∈R, R denotes the number of relationship types, t denotes the current training of t-step reinforcement learning, and Vₜ₊₁ denotes the entity that will arrive next time after selecting a certain state;
definition of a reward and penalty model: a reward mechanism based on user historical interactive data and random reasoning search is designed, a personalized tutorial is constructed based on learning preferences of learners, and the next state is inferred in conjunction with objective learning results; therefore, for the state St of a subject, a reward function is defined:

$$F ( U , T ) = s < U , V > + {\sum }_{i = 1}^{t - 1} s < {V}_{i} , {V}_{t} > ;$$

the reward and penalty model is expressed as:

$${A}_{st} = \{ ( r , {V}_{t + 1} ) , ( {V}_{t} , r , {V}_{t + 1} ) ∈ R \} ;$$

where γ is an arbitrary penalty constant, which is usually used to modify a random selection path of the model, and is set to 1 here; β indicates the satisfaction with learning from learners; θ is an ideal satisfaction constant with a value of 70;
a cumulative reward is expressed as:

$${\sum }_{n = 1}^{t} R = \frac{1}{n} {\sum }_{a , t = 0} ( a \vert {s}_{t} , A ( {s}_{t} ) ) σ R ( {s}_{t + 1} ) ;$$

definition of a transition strategy network: a transition strategy network based on the current state S is constructed based on the reward result; the strategy network takes the current state and the complete path space as inputs, outputs the probability of each action, and then selects the following transition paths:

$$L [ {s}_{t + 1} \vert {s}_{t} , {s}_{t - 1} , … , {s}_{0} , {a}_{t} , {a}_{t - 1} , … , {a}_{0} ] = L [ {s}_{t} , {a}_{t} ] ;$$

hierarchical definition of a deep reinforcement learning model: a prediction layer is added, and the ReLU function is used as an activation function; and the final prediction result is output as follows:

yᵤᵢ=α(Pᵢ^{T}Cᵤ);
where yᵤᵢ∈(0, 1) denotes a learning style tutorial recommended for the next section, a denotes an activation function of converting the input into different contents to form probability, Pᵢ^{T} denotes a vector feature obtained from the learning style tutorial during T training, and Cᵤ denotes the learning tutorial of the previous section;
S12, learning initial learning preferences of users according to evaluation results of learning preferences of users, forming an initial personalized tutorial C0, and performing style adaptability star-rating after the course learning is completed;
S13, combining a multi-modal knowledge map and a reinforcement learning model, starting personalized tutorial revision, inputting two matrices by the model: “learning preferences of learners” and “a course content label”, calculating a weight of a learning style of learning preferences according to the input feature matrix, selecting actions, and constructing course contents;
S14, simulating the interactive data between users and course contents, and generating rewards and states;
S15, iteratively optimizing S12-S15 until the model is capable of automatically constructing a tutorial satisfying the satisfaction of users;
the teaching evaluation module is internally provided with a summary test and a learning effect evaluation method of the learning style tutorial for comparing a teaching effect of a learning style tutorial mode and a teaching effect of a traditional classroom teaching mode.

As a preferred scheme of the present disclosure, the style adaptability star-rating rule is designed as follows:
after learning a section of the course, users perform star-rating on the recommended tutorial learning style with 10 stars: 0.5 stars, 1 star, 1.5 stars, 2 stars, 2.5 stars, 3 stars, 3.5 stars, 4 stars, 4.5 stars and 5 stars;
if users select 0.5 stars, 1 star, 1.5 stars, 2 stars, 2.5 stars, 3 stars, 3.5 stars or 4 stars, users re-evaluate the learning preference scale; the designed deep reinforcement learning model is started with the evaluation result and the multi-modal knowledge map as input features; at this time, the feedback of deep reinforcement learning is a penalty, the output is a new user learning preference type, and a tutorial corresponding to the style weight is generated for the next section according to the matching rule of the learning preference type and the content style;
if users select 4.5 stars or 5 stars, the designed deep reinforcement learning model is started with the historical interactive learning data and the multi-modal knowledge map as input features; at this time, a feedback module of deep reinforcement learning is a reward function, the output is a slightly revised user learning preference type, and a tutorial corresponding to the style weight is generated for the next section according to the matching rule of the learning preference type and the content style.

As a preferred scheme of the present disclosure, the method of constructing the multi-modal knowledge map includes the following steps:
S31, extracting descriptive text formats of all resources based on existing internal databases and external databases, wherein the descriptive text formats include images, videos and descriptive texts, the images, the videos and the descriptive texts are extracted by means of web crawlers, manual annotation and deep learning, and the descriptive texts include texts and audios;
S32, extracting the extracted entities, entity attributes and relationships between entities according to predefined relationships, and sequentially constructing a knowledge map based on pictures, texts, audios and videos, wherein the knowledge map based on pictures and videos is obtained by entity recognition and relationship representation of images and videos; the knowledge map based on texts and audios is obtained by entity recognition of descriptive texts; and a video is constructed by dividing a video into images;
S33, merging the knowledge map based on pictures, texts, audios and videos from an entity alignment level to obtain a multi-modal knowledge map.

As a preferred scheme of the present disclosure, the specific construction process of the multi-modal knowledge map includes:
S41, defining a multi-modal knowledge map MKG=(a, b, c, d, e, f), where a denotes a point set, b denotes an edge set, c denotes a picture set corresponding to all entities, d denotes a text set corresponding to all entities, e denotes a video set corresponding to all entities, and f denotes an audio set corresponding to all entities; the ontology of the multi-modal knowledge map includes two types: an attribute and a relationship, in which the attribute includes a text content, a video content, a picture content and an audio content; and the relationship is defined according to the existing state between entities, including: a prior relationship, a parent-child relationship, a parallel relationship and a style preference relationship;
S42, constructing a multi-modal knowledge map based on the data mode type and the ontology design in conjunction with the attribute type and the relationship definition.

The relationship of the multi-modal knowledge map is defined as follows:

| Relationship | |
|---|---|
| type | Relationship definition |
| Prior | Before learning the course content corresponding to a |
| relationship | particular knowledge entity, you need to complete the |
| | course content corresponding to certain knowledge entities |
| | and pass the corresponding quizzes. |
| parent-child | When a plurality of knowledge entities form a new |
| relationship | knowledge entity in a certain order, there is a parent-child |
| | relationship between the new knowledge entity and the |
| | knowledge entity forming the new knowledge entity. |
| parallel | The knowledge entities are located in the same hierarchical |
| relationship | structure, but have no prior successor or parent-child |
| | relationship and are not in sequence in the learning process. |
| style | This is the relationship between the knowledge entity type |
| preference | attribute and the learning style preference. |
| relationship | |

As a preferred scheme of the present disclosure, the teaching effect evaluation method of the learning style tutorial mode is designed as follows:
after users complete all the sections, the system randomly selects 10 questions from a question bank for the learners for testing, and all the questions come from the external databases;
the test results are recorded and are analyzed with the traditional teacher-lecture evaluation results by using a linear regression equation to determine whether the teaching effect of the learning style is better than that of the traditional classroom teaching mode.

As a preferred scheme of the present disclosure, the method of using the system includes the following steps:
S61: the user logs into the system, the system enters the learning preference evaluation module to evaluate the initial learning style, and the weight value of the learning preference of the user is obtained according to the evaluation result, wherein the learning preference type includes A <active type A1, reflective type A2>, B <feeling type B1, intuitive type B2>, C <visual type C1, literal type C2>, D <sequential type D1, overall type D2>;
S62: after completing the initial evaluation, the system enters the tutorial matching module: one of the top two learning style types in terms of the weight value is randomly selected, and an initial section learning tutorial based on the weights of the text content, the picture content, the audio content, and the video content is generated according to the matching rule of the learning preference type and the content style;
S63: after learning the initial section, the user enters the match revision module: the user performs style adaptability star-rating evaluation on the learning tutorial of the initial section, and the tutorial learning style is revised according to the evaluation result;
S64: repeating the process of “section learning-learning evaluation-match revision” until all sections are learned;
S65: after learning all sections, the system enters the teaching evaluation module, and randomly selects questions from the question bank for testing to verify the learning effect.

The present disclosure has the following beneficial effects. Unlike the traditional method of recommending the whole course resources, Self-GT proposed in the present disclosure can generate personalized tutoring content for a course based on generative learning and cognitive computing methods to meet the learning preferences of different learners.

From the perspective of the time dimension, the present disclosure puts forward a reinforcement learning method to dynamically explore learning preferences of learners in the process of situational learning and describe learning behavior features of learners more accurately.

Based on the internal resource bases and the external resource bases, a plurality of relationships between knowledge points are defined from the perspective of knowledge relevance and knowledge difficulty, and a multi-mode compound relationship knowledge map is constructed, which can help improve the accuracy and the efficiency of a self-method in constructing course contents and ensure the comprehensiveness of resource coverage.

### BRIEF DESCRIPTION OF THE DRAWINGS

FIG. 1 shows an overall flow chart of the present disclosure.

FIG. 2 shows a process of constructing a multi-modal knowledge map according to the present disclosure.

FIG. 3 shows a schematic diagram of a method of revising learning style tutorial contents based on deep reinforcement learning according to the present disclosure.

FIG. 4 shows a performance comparison of two public data sets MOOCCourse and MOOCCube between a method of revising learning style tutorial contents based on deep reinforcement learning according to the present disclosure and methods of MLP, NeuMF, HRL and GMF.

FIG. 5A-FIG. 5E show a diagram of a comparison result between a learning style tutorial mode according to the present disclosure and offline teaching, in which FIG. 5A shows a correlation analysis result diagram of the number of learning times of students and scores of students; FIG. 5B shows a diagram of a correlation analysis result between learning duration of students and scores of students; FIG. 5C shows a diagram of a correlation analysis result between evaluation of students and scores of students; FIG. 5D shows scores of students in a limited time under a mode of “traditional teacher-lecture” and scores of students in 45 and 90 minutes of teaching time; FIG. 5E includes three diagrams from left to right, which are diagrams of the comparison results of scores of students in learning traditional knowledge point 1, knowledge point 2 and knowledge point 3 by using two teaching methods, respectively, wherein the abscissas of the three diagrams are traditional knowledge point 1, knowledge point 2 and knowledge point 3, respectively, the dark color indicates the scores of students using a personal online learning method; and the light color indicates the use of the traditional teaching method.

### DETAILED DESCRIPTION OF THE EMBODIMENTS

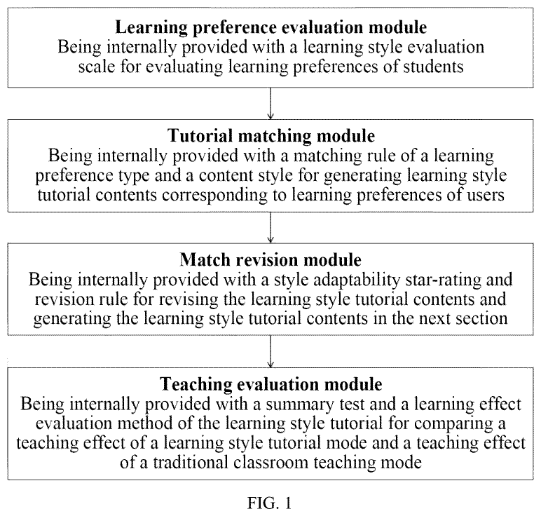

As an embodiment of the present disclosure, as shown in FIG. 1, the system includes a learning preference evaluation module, a tutorial matching module, a match revision module and a teaching evaluation module.

The learning preference evaluation module is internally provided with a learning style evaluation scale for evaluating learning preferences of students.

The tutorial matching module is internally provided with a matching rule of a learning preference type and a content style for generating learning style tutorial contents corresponding to learning preferences of users; wherein the matching rule of the learning preference type and the content style is designed as follows.

The learning preference type includes A <active type A1, reflective type A2>, B <feeling type B1, intuitive type B2>, C <visual type C1, literal type C2>, D <sequential type D1, overall type D2>, the eight types are mutually exclusive, and the final evaluation results include only four types out of the eight types.

The content style includes four styles: a text style, a picture style, a video style and an audio style.

The weights of four content styles corresponding to the active type A1 are [50%, 50%, 50%, 50%, 50%], respectively.

The weights of four content styles corresponding to the reflective type A2 are [60%, 50%, 50%, 50%], respectively.

The weights of four content styles corresponding to the feeling type B1 are [40%, 60%, 60%, 50%], respectively.

The weights of four content styles corresponding to the intuitive type B2 are [40%, 80%, 80%, 60%], respectively.

The weights of four content styles corresponding to the visual type C1 are [30%, 90%, 90%, 50%], respectively.

The weights of four content styles corresponding to the literal type C2 are [90%, 50%, 30%, 40%], respectively.

The weights of four content styles corresponding to the sequential type D1 are [50%, 50%, 30%, 30%], respectively.

The weights of four content styles corresponding to the overall type D2 are [50%, 50%, 50%, 50%, 50%], respectively.

After obtaining the combination of four learning preference types, the text t_p, the picture p_p, the video v_p and the audio a_p are obtained by adding the weights of four content styles and dividing the total weights by 4, that is:

$$t\_p = \frac{{A}_{i} ( 1 ) + {B}_{i} ( 1 ) + {C}_{i} ( 1 ) + {D}_{i} ( 1 )}{4} ;$$

$$p\_p = \frac{{A}_{i} ( 2 ) + {B}_{i} ( 2 ) + {C}_{i} ( 2 ) + {D}_{i} ( 2 )}{4} ;$$

$$v\_p = \frac{{A}_{i} ( 3 ) + {B}_{i} ( 3 ) + {C}_{i} ( 3 ) + {D}_{i} ( 3 )}{4} ;$$

$$a\_p = \frac{{A}_{i} ( 4 ) + {B}_{i} ( 4 ) + {C}_{i} ( 4 ) + {D}_{i} ( 4 )}{4} ;$$

where i=1, 2.

The section tutorial is generated according to the weights of four content styles: if the text t_p, the picture p_p, the video v_p and the audio a_p are 20%, 18%, 50% and 12%, respectively, 20% of the knowledge points in this section are expressed in text, 18% of the knowledge points in this section are expressed in picture, 50% of the knowledge points in this section are expressed in video, and 12% of the knowledge points in this section are expressed in audio.

The match revision module is internally provided with a style adaptability star-rating and revision rule for revising the learning style tutorial contents and generating the learning style tutorial contents in the next section; wherein the revision rule includes the following steps.
S11, a critical definition of the revision rule is given.

Definition of a state: S=(U, V, T) is used to represent the current dynamic state based on a learning path, where U denotes advice to learners, V denotes the entity that a deep reinforcement learning agent arrives at, and T denotes the entity accessed by the agent in which an access path is recorded.

Definition of an action space: after the reinforcement learning agent is in a specific state, it is necessary to obtain the action space in this state, select an action from this space, start the action, and then transmit the action to the next state; wherein the action space is defined as follows:

$${A}_{s t} = \{ ( r , {V}_{t + 1} ) , ( {V}_{t} , r , {V}_{t + 1} ) ∈ R \} ;$$

where r denotes the relationship between entities, r∈R, R denotes the number of relationship types, t denotes the current training of t-step reinforcement learning, and Vₜ₊₁ denotes the entity that will arrive next time after selecting a certain state.

Definition of a reward and penalty model: a reward mechanism based on user historical interactive data and random reasoning search is designed, a personalized tutorial is constructed based on learning preferences of learners, and the next state is inferred in conjunction with objective learning results; therefore, for the state St of a subject, a reward function is defined:

$$F ( U , T ) = s 〈 U , V 〉 + {\sum }_{i = 1}^{t - 1} s 〈 {V}_{i} , {V}_{t} 〉 .$$

The reward and penalty model is expressed as:

$$R ( {s}_{t} ) = \{ \begin{matrix}max ( 0 , F ( U , T ) ) , if β > θ \\ - γ , otherwise\end{matrix} ;$$

where γ is an arbitrary penalty constant, which is usually used to modify a random selection path of the model, and is set to 1 here; β indicates the satisfaction with learning from learners; θ is an ideal satisfaction constant with a value of 70.

A cumulative reward is expressed as:

$${\sum }_{n = 1}^{t} R = \frac{1}{n} {\sum }_{a , t = 0} ( a \vert {s}_{t} , A ( {s}_{t} ) ) σ R ( {s}_{t + 1} ) .$$

Definition of a transition strategy network: a transition strategy network based on the current state S is constructed based on the reward result; the strategy network takes the current state and the complete path space as inputs, outputs the probability of each action, and then selects the following transition paths:

$$L [ {s}_{t + 1} \vert {s}_{t} , {s}_{t - 1} , … , {s}_{0} , {a}_{t} , {a}_{t - 1} , … , {a}_{0} ] = L [ {s}_{t} , {a}_{t} ] .$$

Hierarchical definition of a deep reinforcement learning model: a prediction layer is added, and the ReLU function is used as an activation function; and the final prediction result is output as follows:

yᵤᵢ=α(Pᵢ^{T}Cᵤ);
where yᵤᵢ∈(0, 1) denotes a learning style tutorial recommended for the next section, a denotes an activation function of converting the input into different contents to form probability, Pᵢ^{T} denotes a vector feature obtained from the learning style tutorial during T training, and Cᵤ denotes the learning tutorial of the previous section.
S12, initial learning preferences of users are learned according to evaluation results of learning preferences of users, an initial personalized tutorial C0 is formed, and style adaptability star-rating is performed after the course learning is completed.
S13, a multi-modal knowledge map and a reinforcement learning model are combined, personalized tutorial revision is started, two matrices are input by the model: “learning preferences of learners” and “a course content label”, a weight of a learning style of learning preferences is calculated according to the input feature matrix, actions are selected, and course contents are constructed.
S14, the interactive data between users and course contents is simulated, and rewards and states are generated.
S15, S12-S15 are iteratively optimized until the model is capable of automatically constructing a tutorial satisfying the satisfaction of users.

The teaching evaluation module is internally provided with a summary test and a learning effect evaluation method of the learning style tutorial for comparing a teaching effect of a learning style tutorial mode and a teaching effect of a traditional classroom teaching mode.

The deep reinforcement learning includes five parts: Agent, Environment, State, Action and Reward.

As an embodiment of the present disclosure, the style adaptability star-rating rule is designed as follows.

After learning a section of the course, users perform star-rating on the recommended tutorial learning style with 10 stars: 0.5 stars, 1 star, 1.5 stars, 2 stars, 2.5 stars, 3 stars, 3.5 stars, 4 stars, 4.5 stars and 5 stars.

If users select 0.5 stars, 1 star, 1.5 stars, 2 stars, 2.5 stars, 3 stars, 3.5 stars or 4 stars, users re-evaluate the learning preference scale. The designed deep reinforcement learning model is started with the evaluation result and the multi-modal knowledge map as input features. At this time, the feedback of deep reinforcement learning is a penalty. The output is a new user learning preference type. A tutorial corresponding to the style weight is generated for the next section according to the matching rule of the learning preference type and the content style.

If users select 4.5 stars or 5 stars, the designed deep reinforcement learning model is started with the historical interactive learning data and the multi-modal knowledge map as input features. At this time, a feedback module of deep reinforcement learning is a reward function. The output is a slightly revised user learning preference type. A tutorial corresponding to the style weight is generated for the next section according to the matching rule of the learning preference type and the content style.

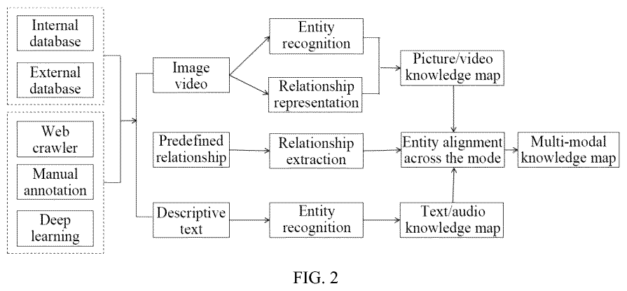

As an embodiment of the present disclosure, as shown in FIG. 2, the process of constructing the multi-modal knowledge map is as follows. The images, the videos and the descriptive texts are extracted from internal databases and external databases by means of web crawlers, manual annotation and deep learning. The descriptive texts include texts and audios; the knowledge map based on pictures and videos is obtained by entity recognition and relationship representation of images and videos. The knowledge map based on texts and audios is obtained by entity recognition of descriptive texts. The extracted entities, entity attributes and relationships between entities are extracted according to predefined relationships. A knowledge map based on pictures, texts, audios and videos is aligned in sequence across the modal entities. The knowledge map based on pictures, texts, audios and videos is merged to obtain a multi-modal knowledge map.

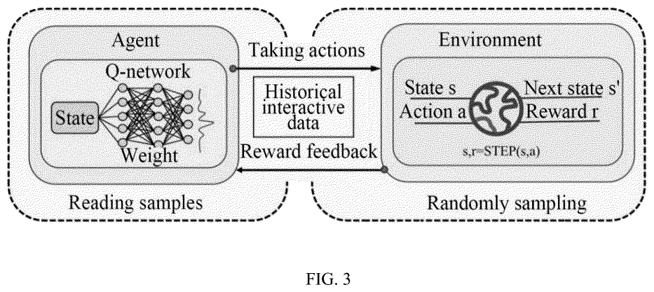

As an embodiment of the present disclosure, as shown in FIG. 3, the revision rule is as follows. Initial learning preferences of users are learned according to evaluation results of learning preferences of users. An initial personalized tutorial is formed. Style adaptability star-rating is performed after the course learning is completed. A multi-modal knowledge map and a reinforcement learning model are combined. Personalized tutorial revision is started. Two matrices are input by the model: “learning preferences of learners” and “a course content label”. A weight of a learning style of learning preferences is calculated according to the input feature matrix. Actions are selected, and course contents are constructed. The interactive data between users and course contents is simulated, and rewards and states are generated. The above process is iteratively optimized until the model is capable of automatically constructing a tutorial satisfying the satisfaction of users.

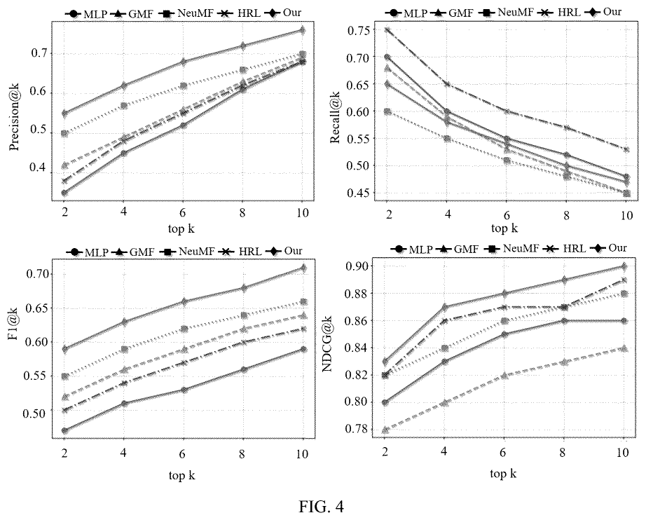

FIG. 4 shows a performance comparison of two public data sets MOOCCourse and MOOCCube between the revision rule and methods of MLP, NeuMF, HRL and GMF. It can be seen from FIG. 4 that the proposed method is significantly improved in terms of accuracy, the recall rate, F1 and Normalized Discounted Cumulative Gain (NDCG) evaluation indexes. The accuracy is improved by 10% to 15%, F1 is improved by 9% to 24%, and NDCG is improved by 3% to 7%. In terms of MOOCCourse and MOOCCube data sets, the proposed method is recommended more accurately than other course recommendation methods. Empirical evidence is provided to the advantages of accurate individual course construction.

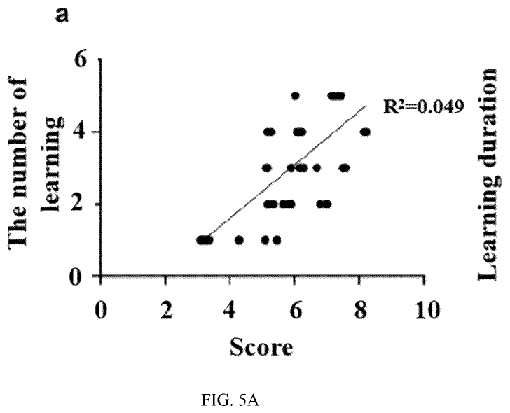

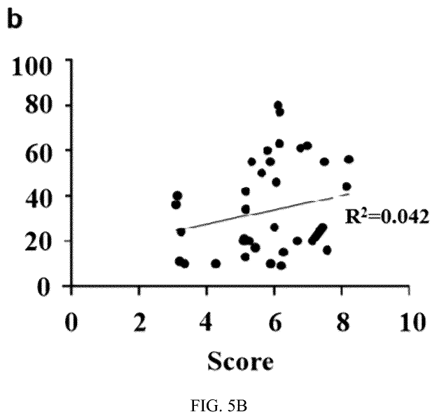

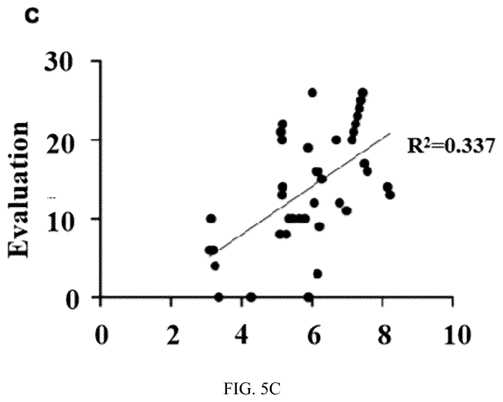

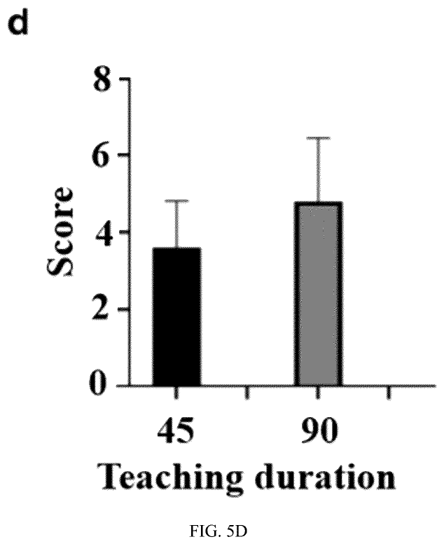

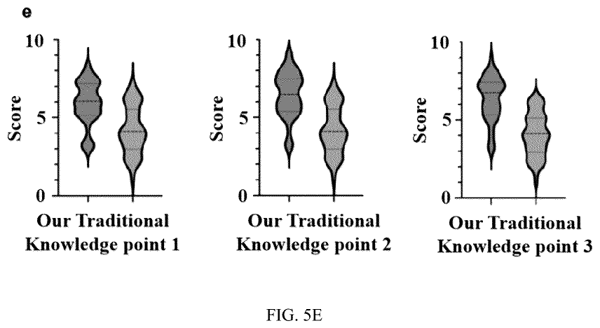

FIG. 5A-FIG. 5E show a comparison result between a learning style tutorial mode according to the present disclosure and offline teaching. The course “Hospital Network Architecture and Planning and Design” is created in the proposed system, and the behaviors of learners are observed and analyzed. Learners need to browse the teaching courses constructed according to preferences of the learners and complete the subsequent exercises or quizzes. In addition, the learners also need to provide evaluation results. The learners are only limited to the students with basic network knowledge. As of August 2023, 80 learners have participated in this experiment and obtained written consent. 40 students of the learners need to complete the online personal learning style tutorial learning provided by the proposed system, and the other 40 students participate in the traditional teaching mode. The linear regression equation is used to compare the teaching effects of the two modes. As shown in FIG. 5A, FIG. 5B and FIG. 5C, the linear regression results are 0.049, 0.042 and 0.337, respectively, all of which are greater than 0, indicating that at least one variable X can explain the change of Y. According to the classification of the number of learning times, learning time and evaluation results, most students have scores above 6 points in the test, which is higher than the average level. The scores of students in the traditional teaching mode are shown in FIG. 5D. In addition, the comparison results of scores of students participating in online personal learning style tutorial and traditional teaching to learn traditional knowledge points 1, 2 and 3 are shown in FIG. 5E. From the results, it can be seen that students who use the proposed system to learn generally achieve higher scores than traditional teaching methods.

What is claimed is:

1. A system of generating multi-style learning tutorials based on learning preference evaluation, wherein the system comprises a learning preference evaluation module, a tutorial matching module, a match revision module and a teaching evaluation module; wherein
the learning preference evaluation module is internally provided with a learning style evaluation scale for evaluating learning preferences of students;
the tutorial matching module is internally provided with a matching rule of a learning preference type and a content style for generating learning style tutorial contents corresponding to learning preferences of users; wherein the matching rule of the learning preference type and the content style is designed as follows:
the learning preference type comprises A <active type A1, reflective type A2>, B <feeling type B1, intuitive type B2>, C <visual type C1, literal type C2>, D <sequential type D1, overall type D2>, the eight types are mutually exclusive, and the final evaluation results comprise only four types out of the eight types;
the content style comprises four styles: a text style, a picture style, a video style and an audio style;
the weights of four content styles corresponding to the active type A1 are [50%, 50%, 50%, 50%, 50%], respectively;
the weights of four content styles corresponding to the reflective type A2 are [60%, 50%, 50%, 50%], respectively;
the weights of four content styles corresponding to the feeling type B1 are [40%, 60%, 60%, 50%], respectively;
the weights of four content styles corresponding to the intuitive type B2 are [40%, 80%, 80%, 60%], respectively;
the weights of four content styles corresponding to the visual type C1 are [30%, 90%, 90%, 50%], respectively;
the weights of four content styles corresponding to the literal type C2 are [90%, 50%, 30%, 40%], respectively;
the weights of four content styles corresponding to the sequential type D1 are [50%, 50%, 30%, 30%], respectively;
the weights of four content styles corresponding to the overall type D2 are [50%, 50%, 50%, 50%, 50%], respectively;
after obtaining the combination of four learning preference types, the text t_p, the picture p_p, the video v_p and the audio a_p are obtained by adding the weights of four content styles and dividing the total weights by 4, that is:
$$t\_p = \frac{{A}_{i} ( 1 ) + {B}_{i} ( 1 ) + {C}_{i} ( 1 ) + {D}_{i} ( 1 )}{4} ;$$
$$p\_p = \frac{{A}_{i} ( 2 ) + {B}_{i} ( 2 ) + {C}_{i} ( 2 ) + {D}_{i} ( 2 )}{4} ;$$
$$v\_p = \frac{{A}_{i} ( 3 ) + {B}_{i} ( 3 ) + {C}_{i} ( 3 ) + {D}_{i} ( 3 )}{4} ;$$
$$a\_p = \frac{{A}_{i} ( 4 ) + {B}_{i} ( 4 ) + {C}_{i} ( 4 ) + {D}_{i} ( 4 )}{4} ;$$
where i=1, 2;
the match revision module is internally provided with a style adaptability star-rating and revision rule for revising the learning style tutorial contents and generating the learning style tutorial contents in the next section; wherein the revision rule comprises the following steps:
S11, giving a critical definition of the revision rule:
definition of a state: S=(U, V, T) is used to represent the current dynamic state based on a learning path, where U denotes advice to learners, V denotes the entity that a deep reinforcement learning agent arrives at, and T denotes the entity accessed by the agent in which an access path is recorded;
definition of an action space: after the reinforcement learning agent is in a specific state, it is necessary to obtain the action space in this state, select an action from this space, start the action, and then transmit the action to the next state; wherein the action space is defined as follows:
$${A}_{s t} = \{ ( r , {V}_{t + 1} ) , ( {V}_{t} , r , {V}_{t + 1} ) ∈ R \} ;$$
where r denotes the relationship between entities, r∈R, R denotes the number of relationship types, t denotes the current training of t-step reinforcement learning, and Vₜ₊₁ denotes the entity that will arrive next time after selecting a certain state;
definition of a reward and penalty model: a reward mechanism based on user historical interactive data and random reasoning search is designed, a personalized tutorial is constructed based on learning preferences of learners, and the next state is inferred in conjunction with objective learning results; therefore, for the state St of a subject, a reward function is defined:
$$F ( U , T ) = s 〈 U , V 〉 + {\sum }_{i = 1}^{t - 1} s 〈 {V}_{i} , {V}_{t} 〉$$
the reward and penalty model is expressed as:
$$R ( {s}_{t} ) = \{ \begin{matrix}max ( 0 , F ( U , T ) ) , if β > θ \\ - γ , otherwise\end{matrix} ;$$
where γ is an arbitrary penalty constant, which is usually used to modify a random selection path of the model, and is set to 1 here; β indicates the satisfaction with learning from learners; θ is an ideal satisfaction constant with a value of 70;
a cumulative reward is expressed as:
$${\sum }_{n = 1}^{t} R = \frac{1}{n} {\sum }_{a , t = 0} ( a \vert {s}_{t} , A ( {s}_{t} ) ) σ R ( {s}_{t + 1} ) ;$$
definition of a transition strategy network: a transition strategy network based on the current state S is constructed based on the reward result; the strategy network takes the current state and the complete path space as inputs, outputs the probability of each action, and then selects the following transition paths:
$$L [ {s}_{t + 1} \vert {s}_{t} , {s}_{t - 1} , … , {s}_{0} , {a}_{t} , {a}_{t - 1} , … , {a}_{0} ] = L [ {s}_{t} , {a}_{t} ] ;$$
hierarchical definition of a deep reinforcement learning model: a prediction layer is added, and the ReLU function is used as an activation function; and the final prediction result is output as follows:
yᵤᵢ=α(Pᵢ^{T}Cᵤ);
where yᵤᵢ∈(0, 1) denotes a learning style tutorial recommended for the next section, a denotes an activation function of converting the input into different contents to form probability, Pᵢ^{T} denotes a vector feature obtained from the learning style tutorial during T training, and Cᵤ denotes the learning tutorial of the previous section;
S12, learning initial learning preferences of users according to evaluation results of learning preferences of users, forming an initial personalized tutorial C0, and performing style adaptability star-rating after the course learning is completed;
S13, combining a multi-modal knowledge map and a reinforcement learning model, starting personalized tutorial revision, inputting two matrices by the model: “learning preferences of learners” and “a course content label”, calculating a weight of a learning style of learning preferences according to the input feature matrix, selecting actions, and constructing course contents;
S14, simulating the interactive data between users and course contents, and generating rewards and states;
S15, iteratively optimizing S12-S15 until the model is capable of automatically constructing a tutorial satisfying the satisfaction of users;
the teaching evaluation module is internally provided with a summary test and a learning effect evaluation method of the learning style tutorial for comparing a teaching effect of a learning style tutorial mode and a teaching effect of a traditional classroom teaching mode.

2. The system of generating multi-style learning tutorials based on learning preference evaluation according to claim 1, wherein the style adaptability star-rating rule is designed as follows:
after learning a section of the course, users perform star-rating on the recommended tutorial learning style with 10 stars: 0.5 stars, 1 star, 1.5 stars, 2 stars, 2.5 stars, 3 stars, 3.5 stars, 4 stars, 4.5 stars and 5 stars;
if users select 0.5 stars, 1 star, 1.5 stars, 2 stars, 2.5 stars, 3 stars, 3.5 stars or 4 stars, users re-evaluate the learning preference scale; the designed deep reinforcement learning model is started with the evaluation result and the multi-modal knowledge map as input features; at this time, the feedback of deep reinforcement learning is a penalty, the output is a new user learning preference type, and a tutorial corresponding to the style weight is generated for the next section according to the matching rule of the learning preference type and the content style;
if users select 4.5 stars or 5 stars, the designed deep reinforcement learning model is started with the historical interactive learning data and the multi-modal knowledge map as input features; at this time, a feedback module of deep reinforcement learning is a reward function, the output is a slightly revised user learning preference type, and a tutorial corresponding to the style weight is generated for the next section according to the matching rule of the learning preference type and the content style.

3. The system of generating multi-style learning tutorials based on learning preference evaluation according to claim 2, wherein the method of constructing the multi-modal knowledge map comprises the following steps:
S31, extracting descriptive text formats of all resources based on existing internal databases and external databases, wherein the descriptive text formats comprise images, videos and descriptive texts, the images, the videos and the descriptive texts are extracted by means of web crawlers, manual annotation and deep learning, and the descriptive texts comprise texts and audios;
S32, extracting the extracted entities, entity attributes and relationships between entities according to predefined relationships, and sequentially constructing a knowledge map based on pictures, texts, audios and videos, wherein the knowledge map based on pictures and videos is obtained by entity recognition and relationship representation of images and videos; the knowledge map based on texts and audios is obtained by entity recognition of descriptive texts; and a video is constructed by dividing a video into images;
S33, merging the knowledge map based on pictures, texts, audios and videos from an entity alignment level to obtain a multi-modal knowledge map.

4. The system of generating multi-style learning tutorials based on learning preference evaluation according to claim 3, wherein the specific construction process of the multi-modal knowledge map comprises:
S41, defining a multi-modal knowledge map MKG=(a, b, c, d, e, f), where a denotes a point set, b denotes an edge set, c denotes a picture set corresponding to all entities, d denotes a text set corresponding to all entities, e denotes a video set corresponding to all entities, and f denotes an audio set corresponding to all entities; the ontology of the multi-modal knowledge map comprises two types: an attribute and a relationship, in which the attribute includes a text content, a video content, a picture content and an audio content; and the relationship is defined according to the existing state between entities, comprising: a prior relationship, a parent-child relationship, a parallel relationship and a style preference relationship;
S42, constructing a multi-modal knowledge map based on the data mode type and the ontology design in conjunction with the attribute type and the relationship definition.

5. The system of generating multi-style learning tutorials based on learning preference evaluation according to claim 1, wherein the teaching effect evaluation method of the learning style tutorial mode is designed as follows:
after users complete all the sections, the system randomly selects 10 questions from a question bank for the learners for testing, and all the questions come from the external databases; the test results are recorded and are analyzed with the traditional teacher-lecture evaluation results by using a linear regression equation to determine whether the teaching effect of the learning style is better than that of the traditional classroom teaching mode.

6. The system of generating multi-style learning tutorials based on learning preference evaluation according to claim 1, wherein the method of using the system comprises the following steps:
S61: the user logs into the system, the system enters the learning preference evaluation module to evaluate the initial learning style, and the weight value of the learning preference of the user is obtained according to the evaluation result, wherein the learning preference type comprises A <active type A1, reflective type A2>, B <feeling type B1, intuitive type B2>, C <visual type C1, literal type C2>, D <sequential type D1, overall type D2>;
S62: after completing the initial evaluation, the system enters the tutorial matching module: one of the top two learning style types in terms of the weight value is randomly selected, and an initial section learning tutorial based on the weights of the text content, the picture content, the audio content, and the video content is generated according to the matching rule of the learning preference type and the content style;
S63: after learning the initial section, the user enters the match revision module: the user performs style adaptability star-rating evaluation on the learning tutorial of the initial section, and the tutorial learning style is revised according to the evaluation result;
S64: repeating the process of “section learning-learning evaluation-match revision” until all sections are learned;
S65: after learning all sections, the system enters the teaching evaluation module, and randomly selects questions from the question bank for testing to verify the learning effect.
